(19) United States
(12) Patent Application Publication
(10) Pub. No.: US 2026/0048399 A1
(43) Pub. Date: Feb. 19, 2026

(54) INTERLOCKING CONES SYSTEM FOR ATTACHING A ROTOR

(71) Applicant: FIBERLITE CENTRIFUGE LLC, Santa Clara, CA (US)

(72) Inventor: Sina PIRAMOON, Santa Clara, CA (US)

(21) Appl. No.: 18/996,178

(22) PCT Filed: Jul. 18, 2023
(86) PCT No.: PCT/US2023/028076

§ 371 Date: Jan. 17, 2025

Related U.S. Application Data
(60) Provisional application No. 63/392,963, filed on Jul. 28, 2022.

(51) Int. Cl. B04B 9/08

(52) U.S. Cl. CPC B04B 9/08

(57) ABSTRACT

A drive head (20) of a centrifuge drive for detachably connecting a rotor to the centrifuge. The drive head includes a drive head hub (66) including a plurality of recesses (70) formed in an outer sidewall, a locking shoe (74) movably retained within each of the plurality of recesses by the retaining plate (68) so as to be pivotable about a pivot axis in a radially inward direction and a radially outward direction relative to the rotational axis of the centrifuge drive, and a resilient element (92) for biasing each locking shoe in the radially outward direction. Each locking shoe is configured to exert a radially outwardly directed force on an interior sidewall of the hub (22) of the centrifuge rotor to prevent axial movement of the centrifuge rotor along the rotational axis of the centrifuge drive and rotational movement of the centrifuge rotor relative to the drive head, with the radially outwardly directed force increasing with a rising rotational speed of the drive head.

### TECHNICAL FIELD

This invention relates generally to centrifuges and, more particularly, to a drive head locking system of a centrifuge drive for detachably connecting a rotor to the centrifuge.

### BACKGROUND

Laboratory centrifuges generally include a rotor removably coupled to a drive for rotating the rotor at a particular speed required for the centrifuging of samples stored in the rotor. While centrifuge rotors may vary significantly in construction and in size, common rotor structures are a fixed-angle rotor and a swinging-bucket rotor (also referred to as a swing-out rotor). The fixed-angle rotor, for example, includes a solid rotor body with a plurality of receiving chambers, or rotor wells, distributed radially within the rotor body and arranged symmetrically about an axis of rotation of the rotor. Samples in sample containers of appropriate size are placed in the plurality of rotor wells, allowing a plurality of samples to be subjected to centrifugation when the rotor is rotated by the centrifuge drive.

To cause the rotor to rotate at a particular speed, the rotor is removably attached to a drive shaft, or spindle, of the centrifuge that is driven by a motor. In this regard, the centrifuge spindle typically includes a locking system configured to be received by the rotor for both securing the rotor to the centrifuge drive and transmitting torque between the drive and the rotor for rotation of the rotor at a particular speed. One type of conventional locking system is one that is operated by centrifugal force. That is, with increasing rotational speed of the rotor, the coupling force exerted by the coupling device on the rotor increases. However, these conventional types of locking systems often require the use of tools to initially couple and to decouple the rotor and the centrifuge drive. Other conventional locking system designs include an integrated actuator or push button operable to initially couple and to decouple the rotor and the centrifuge drive, for example. To this end, the use of tools or other mechanisms to mechanically couple the rotor to the centrifuge drive is a result of the limited performance capabilities of centrifugally operated locking systems, being limited by their ability to accommodate torque and the associated axial forces caused by centrifugal forces during rotation of the centrifuge rotor by the centrifuge drive, particularly at high rotational speeds.

Therefore, a need exists to provide a centrifuge which ensures reliable locking against both rotational forces and axial lifting forces acting against the centrifuge rotor during a range of rotational speeds, but particularly at high rotational speeds, with the locking force increasing with the rising rotational speed of the centrifuge rotor. Furthermore, the rotor should be able to be mountable to and dismountable from the centrifuge drive in a very short period of time and without the use of tools, pushbuttons, or other mechanical actuators, for example.

### SUMMARY

The present invention overcomes the foregoing and other shortcomings and drawbacks of centrifuge drive head locking systems for detachably connecting a rotor to the centrifuge drive. While the present invention will be discussed in connection with certain embodiments, it will be understood that the present invention is not limited to the specific embodiments described herein.

According to one embodiment of the invention, a drive head for a centrifuge drive is provided. The drive head is configured to be received within a hub of a centrifuge rotor for coupling the centrifuge rotor to the centrifuge drive for rotation of the centrifuge rotor by the centrifuge drive about a rotational axis of the centrifuge drive. The hub of the centrifuge rotor includes at least one torque slot formed therein. The drive head includes a drive head hub with a spindle socket configured to receive a spindle of the centrifuge drive and a central bore configured to receive a fastener therethrough to couple the drive head to the spindle. The drive head hub includes a boss that projects upwardly from a top surface of the drive head hub, the boss including at least one drive pin configured to engage the at least one torque slot formed in the hub of the centrifuge rotor to transfer rotational movement of the centrifuge drive to the centrifuge rotor, and a plurality of recesses formed in an outer sidewall of the drive head hub and spaced circumferentially about the drive head hub. The drive head further includes a retaining plate attached to a base of the drive head hub, the retaining plate including a central bore configured to receive a distal end of the spindle therethrough, a locking shoe movably retained within each of the plurality of recesses by the retaining plate so as to be pivotable about a pivot axis in a radially inward direction and a radially outward direction relative to the rotational axis of the centrifuge drive, and a resilient element located between and in operative engagement with each respective locking shoe and the retaining plate for biasing each locking shoe in the radially inward direction relative to the rotational axis of the centrifuge drive. To this end, each locking shoe is configured to exert a radially outwardly directed force on a tapered section of an interior sidewall of the hub of the centrifuge rotor during rotation of the centrifuge rotor by the centrifuge drive to prevent axial movement of the centrifuge rotor along the rotational axis of the centrifuge drive and rotational movement of the centrifuge rotor relative to the drive head, with the radially outwardly directed force increasing with a rising rotational speed of the drive head.

According to one aspect of the present invention, each locking shoe includes a curved outer surface in transverse cross-section that matches a curvature of the interior sidewall of the hub of the centrifuge rotor. According to another aspect of the present invention, each locking shoe includes a rounded surface that extends between the curved outer surface and a top surface of each locking shoe that is configured to engage a shoulder formed in the interior sidewall of the hub of the centrifuge.

According to one aspect of the present invention, each locking shoe is pivotable between (1) a retracted position wherein each locking shoe is received within a corresponding one of the plurality of recesses in a radially inward direction relative to the rotational axis of the centrifuge drive to define a first outer diameter of the drive head hub and (2) an extended position wherein each locking shoe projects a distance from the corresponding one of the plurality of recesses in a radially outward direction relative to the rotational axis of the centrifuge drive to define a second outer diameter of the drive head hub that is greater than the first outer diameter.

According to yet another aspect of the present invention, the plurality of recesses are spaced equidistantly apart about a circumference of the drive head hub to provide self-centering of the drive head within the hub of the centrifuge rotor by each locking shoe. According to one aspect of the present invention, the pivot axis is perpendicular to the rotational axis of the centrifuge drive. According to another aspect of the present invention, each locking shoe includes a first pin that projects from a first side of the locking shoe and a second pin that projects from a second side of the locking shoe, wherein the first pin and the second pin define the pivot axis of the locking shoe. According to one aspect of the present invention, each of the plurality of recesses includes a first sidewall having a first slot configured to movably receive the first pin of the locking shoe therein and a second sidewall having a second slot configured to movably receive the second pin of the locking shoe therein.

According to one aspect of the present invention, the locking shoe includes a pad that projects from a back side of the locking shoe, the pad being configured to abut the drive head hub when the locking shoe is in the retracted position and be spaced away from the drive head hub when the locking shoe is in the extended position. According to another aspect of the present invention, the resilient element extends between a blind bore formed in a base of the locking shoe and a blind bore formed in the retaining plate. According to yet another aspect of the present invention, the at least one drive pin comprises a first, second, and third drive pin spaced apart circumferentially about the central bore of the drive head hub.

According to another embodiment of the present invention, a centrifuge is provided with the drive head and includes a centrifuge rotor that includes a hub configured to receive the drive head therein, the hub including at least one torque slot formed therein that is configured to receive the at least one drive pin of the drive head hub for transferring rotational movement of the centrifuge drive to the centrifuge rotor.

According to one aspect of the invention, the hub of the centrifuge rotor includes an interior sidewall having a tapered section that defines a shoulder, wherein each locking shoe is configured to exert a radially outwardly directed force on the tapered section and shoulder of the interior sidewall of the hub during rotation of the centrifuge rotor by the centrifuge drive. According to another aspect of the invention, each torque slot is an arc-shaped blind bore. According to yet another aspect of the invention, the at least one torque slot comprises four torque slots spaced apart circumferentially about a central bore formed in the hub. According to one aspect of the invention, a first drive pin of the drive head hub is configured to engage a sidewall of a first torque slot to prevent rotation of the drive head relative to the centrifuge rotor during acceleration of the centrifuge rotor by the centrifuge drive. According to another aspect, a second drive pin of the drive head hub is configured to engage a sidewall of a second torque slot to prevent rotation of the drive head relative to the centrifuge rotor during deceleration of the centrifuge rotor by the centrifuge drive.

According to another embodiment of the present invention, a drive head for a centrifuge drive is provided. The drive head is configured to be received within a hub of a centrifuge rotor for coupling the centrifuge rotor to the centrifuge drive for rotation of the centrifuge rotor by the centrifuge drive about a rotational axis of the centrifuge drive. The hub of the centrifuge rotor includes at least one drive pin for transferring rotational movement of the centrifuge drive to the centrifuge rotor. The drive head includes a drive head hub including a spindle socket configured to receive a spindle of the centrifuge drive and a central bore configured to receive a fastener therethrough to couple the drive head to the spindle. The drive head hub includes a plurality of recesses formed in an outer sidewall of the drive head hub and spaced circumferentially about the drive head hub, a retaining plate attached to a base of the drive head hub, the retaining plate including a central bore configured to receive a distal end of the spindle therethrough. The drive head further includes a locking shoe movably retained within each of the plurality of recesses by the retaining plate so as to be pivotable about a pivot axis in a radially inward direction and a radially outward direction relative to the rotational axis of the centrifuge drive and a resilient element located between and in operative engagement with each respective locking shoe and the retaining plate for biasing each locking shoe in the radially inward direction relative to the rotational axis of the centrifuge drive. To this end, each locking shoe is configured to exert a radially outwardly directed force on a tapered section of an interior sidewall of the hub of the centrifuge rotor during rotation of the centrifuge rotor by the centrifuge drive to prevent axial movement of the centrifuge rotor along the rotational axis of the centrifuge drive and rotational movement of the centrifuge rotor relative to the drive head, with the radially outwardly directed force increasing with a rising rotational speed of the drive head.

According to one aspect of the present invention, the drive head includes a crown attached to a top of the drive head hub. The crown includes a central bore configured to receive the fastener therethrough and a plurality of torque slots formed in a top surface of the crown that are configured to receive the at least one drive pin of the hub of the centrifuge rotor therein to transfer rotational movement of the centrifuge drive to the centrifuge rotor.

According to another aspect of the present invention, each locking shoe includes a curved outer surface in transverse cross-section that matches a curvature of the interior sidewall of the hub of the centrifuge rotor. According to one aspect of the present invention, each locking shoe includes a rounded surface that extends between the curved outer surface and a top surface of each locking shoe that is configured to engage a shoulder formed in the interior sidewall of the hub of the centrifuge.

According to yet another aspect of the present invention, each locking shoe is pivotable between (1) a retracted position wherein each locking shoe is received within a corresponding one of the plurality of recesses in a radially inward direction relative to the rotational axis of the centrifuge drive to define a first outer diameter of the drive head hub and (2) an extended position wherein each locking shoe projects a distance from the corresponding one of the plurality of recesses in a radially outward direction relative to the rotational axis of the centrifuge drive to define a second outer diameter of the drive head hub that is greater than the first outer diameter.

According to one aspect of the present invention, the plurality of recesses are spaced equidistantly apart about a circumference of the drive head hub to provide self-centering of the drive head within the hub of the centrifuge rotor by each locking shoe. According to another aspect of the present invention, the pivot axis is perpendicular to the rotational axis of the centrifuge drive. According to one aspect of the present invention, each locking shoe includes a first pin that projects from a first side of the locking shoe and a second pin that projects from a second side of the locking shoe, wherein the first pin and the second pin define the pivot axis of the locking shoe.

According to one aspect of the present invention, each of the plurality of recesses includes a first sidewall having a first slot configured to movably receive the first pin of the locking shoe therein and a second sidewall having a second slot configured to movably receive the second pin of the locking shoe therein. According to another aspect of the present invention, the locking shoe includes a pad that projects from a back side of the locking shoe. The pad is configured to abut the drive head hub when the locking shoe is in the retracted position and be spaced away from the drive head hub when the locking shoe is in the extended position. According to one aspect of the present invention, the resilient element extends between a blind bore formed in a base of the locking shoe and a blind bore formed in the retaining plate.

According to one aspect of the present invention, a centrifuge is provided with the drive head and includes a centrifuge rotor with a hub configured to receive the drive head therein. The hub includes at least one drive pin that projects from an interior surface of the hub in an axially downward direction relative to the rotational axis of the centrifuge drive, the at least one drive pin configured to transfer rotational movement of the centrifuge drive to the centrifuge rotor.

According to another aspect of the present invention, the hub of the centrifuge rotor includes an interior sidewall having a tapered section that defines a shoulder. Each locking shoe is configured to exert a radially outwardly directed force on the tapered section and shoulder of the interior sidewall of the hub during rotation of the centrifuge rotor by the centrifuge drive. According to yet another aspect of the present invention, each torque slot is an arc-shaped blind bore. According to one aspect of the present invention, the at least one torque slot comprises four torque slots spaced apart circumferentially about a central bore formed in the hub.

According to one aspect of the present invention, a first drive pin of the crown is configured to engage a sidewall of a first torque slot to prevent rotation of the drive head relative to the centrifuge rotor during acceleration of the centrifuge rotor by the centrifuge drive. According to another aspect of the present invention, a second drive pin of the crown of the centrifuge rotor is configured to engage a sidewall of a second torque slot to prevent rotation of the drive head relative to the centrifuge rotor during deceleration of the centrifuge rotor by the centrifuge drive.

According to another embodiment of the present invention, an adapter for mounting a drive head to a spindle of a centrifuge drive is provided. The drive head is configured to be received within a hub of a centrifuge rotor for coupling the centrifuge rotor to the centrifuge drive for rotation of the centrifuge rotor by the centrifuge drive about a rotational axis of the centrifuge drive. The drive head includes a central bore configured to receive a fastener therethrough to couple the drive head to a distal end of the spindle of the centrifuge drive. The adapter includes a first projection configured to be received within a pocket formed in the drive head, a second projection that projects in an axially opposite direction from the first projection, and a mounting bore that extends axially through the adapter and between a first opening to the mounting bore formed in the first projection of the adapter and a second opening to the mounting formed in the second projection of the adapter. The mounting bore is configured to receive the distal end of the spindle through the second opening such that the central bore of the drive head, the mounting bore, and a threaded bore in the distal end of the spindle are coaxially arranged to receive the fastener therethrough to couple the drive head and the adapter to the distal end of the spindle of the centrifuge drive.

According to one aspect of the present invention, the adapter includes a cupped flange located axially between the first projection and the second projection. According to another aspect of the present invention, the first projection is frustoconical in shape. According to one aspect of the present invention, the mounting bore is frustoconical in shape.

Various additional features and advantages of the invention will become more apparent to those of ordinary skill in the art upon review of the following detailed description of one or more illustrative embodiments taken in conjunction with the accompanying drawings.

### BRIEF DESCRIPTION OF THE DRAWINGS

The accompanying drawings, which are incorporated in and constitute a part of this specification, illustrate one or more embodiments of the invention and, together with the general description given above and the detailed description given below, serve to describe the one or more embodiments of the invention.

FIG. 1 is a cross-sectional view of a centrifuge, illustrating a centrifuge rotor coupled to a drive head of a centrifuge drive in accordance with a first embodiment of the invention.

FIG. 2 is an enlarged cross-sectional view of the centrifuge of FIG. 1, illustrating additional details of the drive head.

FIG. 3 is a sectional view taken along line 3-3 in FIG. 2, illustrating a position of the locking shoes of the drive head when the drive head is stationary.

FIG. 4 is a view similar to FIG. 3, illustrating movement of the locking shoes of the drive head when the drive head is rotating the centrifuge rotor at a particular speed.

FIG. 4A is an enlarged view of the engagement between a locking shoe and the centrifuge rotor of FIG. 4, illustrating the forces exerted by each locking shoe on the hub of the centrifuge rotor when the centrifuge rotor is rotating at a particular speed.

FIG. 5 is a cross-sectional view taken along line 5-5 in FIG. 4, illustrating forces acting on the locking shoes of the drive head when the drive head is rotating the centrifuge rotor at a particular speed.

FIG. 6 is a cross-sectional view taken along line 6-6 in FIG. 4, illustrating additional details of the drive head and the locking shoes.

FIG. 7 is a cross-section view taken along line 7-7 in FIG. 4, illustrating a position of the drive pins relative to corresponding torque slots in a hub of the centrifuge rotor when the drive head is rotating the centrifuge rotor at a particular speed in a clockwise direction.

FIG. 8 is a view similar to FIG. 7, illustrating a position of drive pins relative to corresponding torque slots in the hub of the rotor when the drive head is decelerating to a stop.

FIG. 9 is an exploded disassembled view of the drive head of FIGS. 1-8.

FIG. 10 is an enlarged cross-sectional view of a centrifuge, illustrating a centrifuge rotor coupled to a drive head of a centrifuge drive in accordance with a second embodiment of the invention.

FIG. 11 is a sectional view taken along line 11-11 in FIG. 10, illustrating a position of drive pins relative to corresponding torque slots in the drive head when the drive head is rotating the centrifuge rotor at a particular speed in a clockwise direction.

FIG. 12 is a view similar to FIG. 11, illustrating a position of drive pins relative to corresponding torque slots in the drive head when the drive head is decelerating to a stop.

FIG. 13 is a cross-sectional view of a drive head attached to a spindle of a centrifuge with an adapter in accordance with an embodiment of the invention.

FIG. 14 is a diagrammatic view showing a centrifuge rotor installed in an exemplary centrifuge.

### DETAILED DESCRIPTION

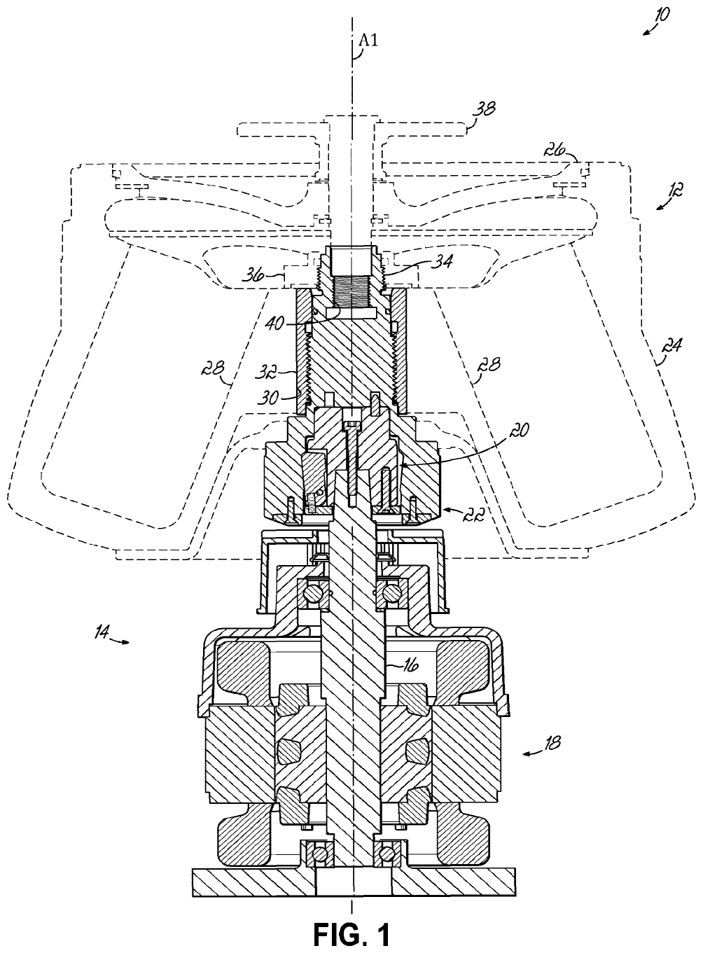

Referring now to the figures, and in particular to FIG. 1, an exemplary centrifuge 10 in accordance with a first embodiment of the present invention is shown without any substructure of the centrifuge 10. As shown in FIG. 1, the centrifuge 10 includes a centrifuge rotor 12 operatively coupled to a centrifuge drive 14 having a drive shaft, or spindle 16, driven by a motor 18 for rotating the rotor 12 about a rotational axis A1 to achieve high-speed, centrifugal rotation of the rotor 12. As shown, the centrifuge drive 14 includes a drive head 20 positioned at one end of the spindle 16 that is configured to be received within a hub 22 of the rotor 12 for detachably connecting the rotor 12 to the centrifuge drive 14 in a tool-less manner, as will be described in further detail below. The connection between the drive head 20 and the rotor 12 both axially secures the rotor 12 to the centrifuge drive 14 as well as facilitates the transfer of torque between the centrifuge drive 14 and the rotor 12 to cause the rotor 12 to rotate with a rotation required for centrifugation of samples contained therein. The connection also provides for self-centering of the drive head 20 within the hub 22 of the rotor 12, as will be described in further detail below.

With continued reference to FIG. 1, the exemplary centrifuge rotor 12 includes a rotor body 24 and a rotor lid 26 configured to be coupled to an open end of the rotor body 24, particularly during centrifugation of a sample, for example. In that regard, the rotor body 24 is symmetrical about the axis of rotation A1 shared with the centrifuge drive 14. The rotor 12 includes a plurality of rotor wells 28 (otherwise referred to as receiving chambers or cell hole cavities) formed in the rotor body 24 and distributed radially, in a symmetrical arrangement, about a vertical bore 30 formed through the axial center of the rotor 12. Each rotor well 28 formed in the rotor body 24 is generally cylindrical in shape and is configured to receive a sample container (not shown) therein for centrifugation of a sample held in the sample container. Each rotor well 28 may be formed in the rotor body 24 so as to have a fixed angular relationship relative to the rotational axis A1 of the rotor 12. To this end, the rotor 12 may be considered a high-speed fixed-angle rotor 12, for example, which is designed to rotate at rotational speeds in the range of about 8,000 rpm to about 30,000 rpm.

While the rotor 12 is shown and described in the context of a fixed-angle rotor having certain characteristics, it will be understood that the same inventive concepts related to embodiments of the present invention may be implemented with different types of centrifuge rotors such as swinging-bucket rotors and vertical rotors, for example, without departing from the scope of the invention. For example, the inventive concepts related to embodiments of the present invention may be implemented with the following rotors (listed by model number) commercially available from the Assignee of the present disclosure: Fiberlite™ F10-6x250 LEX, Fiberlite™F10-6x100 LEX, Fiberlite™F15-6x100y, Fiberlite™F15-8x50cy, Fiberlite™ F15-48x1.5/2.0, Fiberlite™F10-14x50cy, H3-LV, Fiberlite™F15-24x1.5/2.0, BIOShield™-720, TX-100, TX-150, TX-200, TX-400, TX-750, HIGHPlate™-6000, Fiberlite™F9-6x1000 LEX, Fiberlite™F21-8x50y, Fiberlite™F12-6x500 LEX, Fiberlite™F10-4x1000 LEX, Fiberlite™F20-12x50 LEX, Fiberlite™F14-14x50cy, Fiberlite™F23-48x1.5, Fiberlite™F14-6x250y, Fiberlite™F30-8x100, Fiberlite™F30-8x50, Fiberlite™F17-6x250 LEX. To this end, the drawings are not intended to be limiting.

With continued reference to FIG. 1, the rotor 12 includes a rotor insert 32 provided within a central interior region of the rotor body 24 that is configured to threadably engage the rotor hub 22. As shown, the rotor insert 32 is located about the rotational axis A1 and is configured to receive and threadedly engage the rotor hub 22 to hold the rotor hub 22 in place within the vertical bore 30 of the rotor 12. The engagement between the rotor insert 32 and the rotor hub 22 results in an externally threaded top portion 34 of the hub 22 being exposed from the vertical bore 30 to which a hub retainer 36 is threadably fastened to hold the hub 22 in place relative to the rotor body 24.

The rotor 12 further includes a lid screw 38 for securing the rotor lid 26 to the rotor body 24. The lid screw 38 is configured to thread into an internally threaded top portion 40 of the rotor hub 22 such that turning of the lid screw 38 to engage the hub 22 causes the lid screw 38 to press down on the lid 26, securing the lid 26 to the rotor 12. As shown, the lid screw 38, hub 22, and rotor insert 32 are coaxially arranged with the vertical bore 30 formed in the rotor body 24. The lid 26 seals closed the open end of the rotor body 24 to block access to one or more sample containers held in the rotor wells 28 during high speed rotation of the rotor 12.

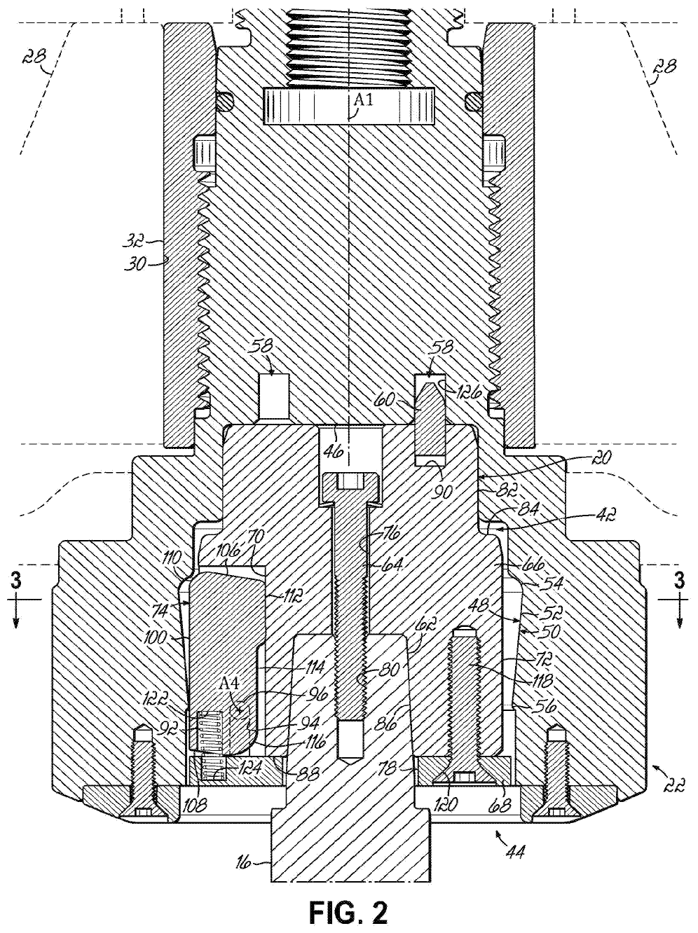

Referring now to FIGS. 1-2, the hub 22 of the rotor 12 includes an internal cavity 42 configured to receive the drive head 20 of the centrifuge drive 14 therein for coupling the rotor 12 to the centrifuge drive 14. As shown, the internal cavity 42 extends from an open end 44 of the hub 22 to a radially extending base surface 46 of the hub 22 to define an interior sidewall 48 of the hub 22. The interior sidewall 48 of the hub 22 is generally stepped to correspond to a profile of the drive head 20. More particularly, the interior sidewall 48 includes a frustoconical shaped portion 50 configured to receive one or more locking shoes of the drive head hub 22 during rotation of the centrifuge rotor 12 by the centrifuge drive 14, as described in further detail below. The frustoconical portion 50 is defined by a tapered section 52 of the sidewall 48 and a shoulder 54. The tapered section 52 of the sidewall 48 extends from a lip 56 formed on the interior sidewall 48 of the hub 22 to the shoulder 54 to define a height of the tapered section 52. As shown, as the tapered section 52 of the sidewall 48 extends from the lip 56 to the shoulder 54, the tapered section 52 extends gradually in a radially outwardly direction relative to the rotational axis A1. In that regard, the tapered section 52 extends at an angle of between 5° to 30° relative to vertical (e.g., the rotational axis A1). As a result, a first inner diameter (“ID”) of the frustoconical portion 50 of the sidewall 48 measured at or near the shoulder 54 is greater than a second ID of the frustoconical portion 50 measured at or near the lip 56. The base surface 46 of the hub 22 includes a plurality of torque slots 58 formed therein with each torque slot 58 being configured to receive a corresponding drive pin 60 of the drive head 20 therein to transfer rotational movement of the centrifuge drive 14 to the centrifuge rotor 12, as described in further detail below.

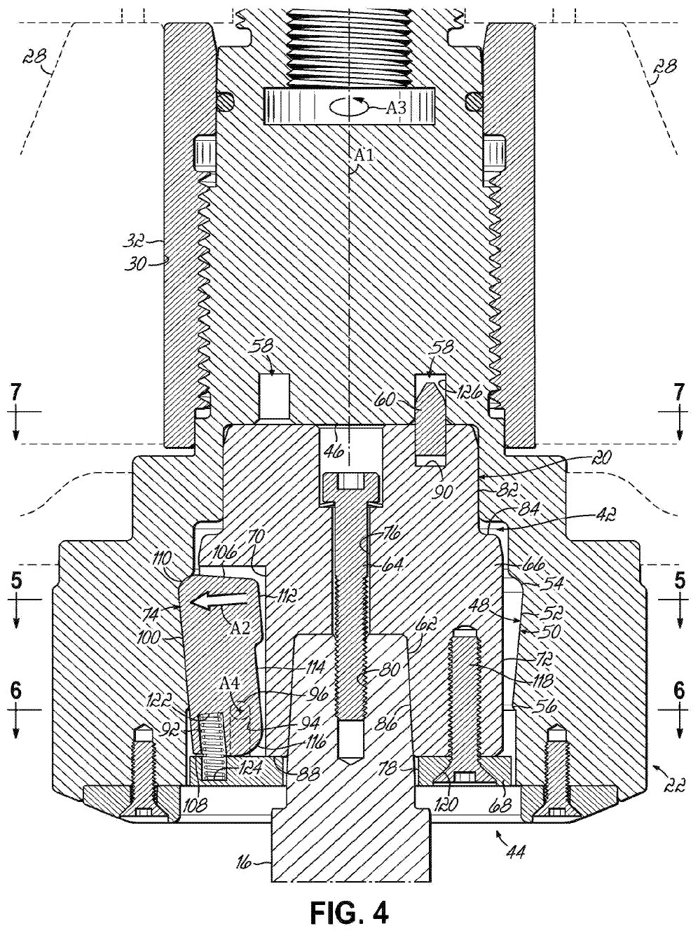

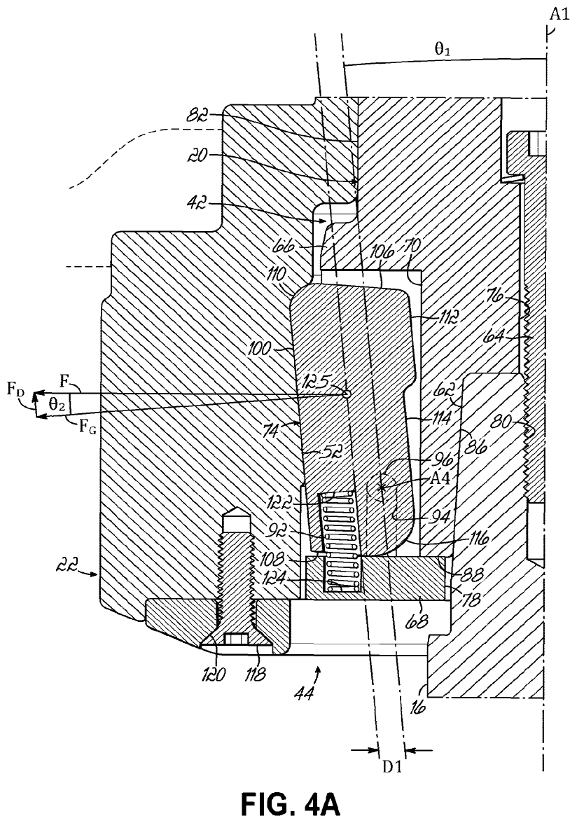

With reference to FIGS. 2-4 and 9, details of the drive head 20 will now be described. As shown, the drive head 20 is permanently mounted to a distal end 62 of the spindle 16 with a fastener 64 and includes a drive head hub 66 and a retaining plate 68 coupled together in a coaxial arrangement. The drive head hub 66 further includes a plurality of recesses 70 formed in an outer sidewall 72 of the drive head hub 66 with each recess 70 being configured to movably retain a respective locking shoe 74 therein. As shown in FIG. 4, the plurality of radially movable locking shoes 74 are movable in a radially outwardly direction, as indicated by directional arrow A2, when the rotor 12 is rotating at a particular speed, as indicated by directional arrow A3. As described in further detail below, each locking shoe 74 is configured to exert a radially outwardly directed centrifugal force F on the hub 22 of the rotor 12. To this end, the radially outwardly directed force F exerted on the hub 22 of the rotor 12 by each locking shoe 74 increases with a rising rotational speed of the drive head 20. In that regard, the locking shoes 74 serve to prevent axial movement of the centrifuge rotor 12 along the rotational axis A1 of the centrifuge drive 14 as well as rotational movement of the centrifuge rotor 12 relative to the drive head 20, and further provide for self-centering of the drive head 20 within the hub 22 of the rotor 12, as described in further detail below.

As best shown in FIGS. 2 and 4, the drive head hub 66 includes a central bore 76 configured to receive the fastener 64 therethrough for attaching the drive head 20 to the distal end 62 of the spindle 16. The retaining plate 68 includes a central bore 78 configured to receive the distal end 62 of the spindle 16 therethrough. To this end, the fastener 64, which may be a bolt or screw, for example, is received through the bore 76 formed in the drive head hub 66 and threaded into a threaded bore 80 in the distal end 62 of the spindle 16.

With reference to FIGS. 2, 4 and 9, the drive head hub 66 includes a generally cylindrical boss 82 that projects upwardly from a top surface 84 of the drive head hub 66 and a pocket 86, otherwise referred to as a spindle socket, formed in a base 88 of the drive head hub 66. The pocket 86 extends a distance into the drive head hub 66 in an axial direction from the base 88 and is configured to receive a portion of the distal end 62 of the spindle 16 therein, as shown. The profile of the pocket 86 achieves the same effect as a locking cone or morse taper, resulting in a self-holding frictional engagement between surfaces of the pocket 86 and surfaces of the spindle 16. The central bore 76 formed in the drive head hub 66 extends in an axial direction between the boss 82 and the pocket 86 and is configured to receive the fastener 64 therethrough, as described above.

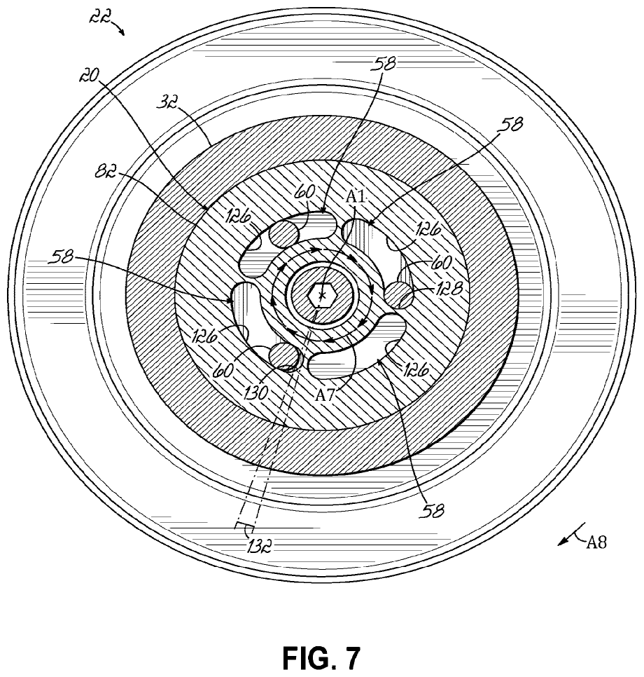

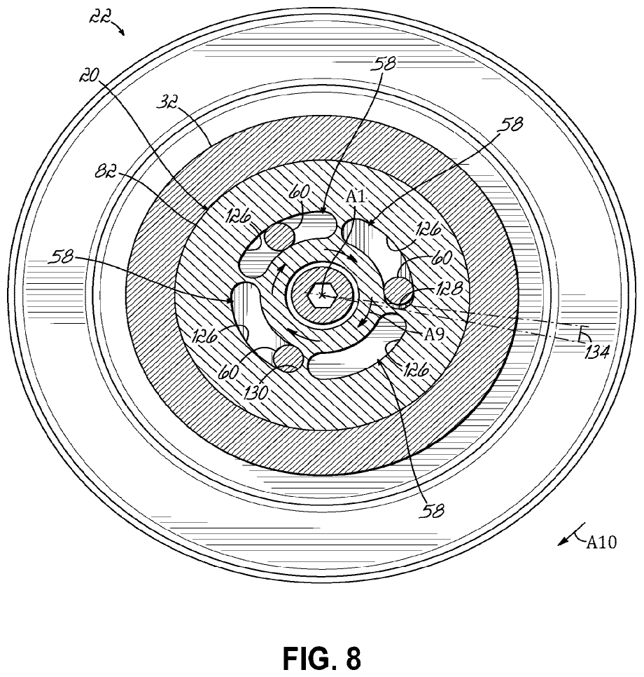

With continued reference to FIGS. 2, 4 and 9, the drive head hub 66, and more particularly the boss 82, includes a plurality of blind bores 90 formed therein with each blind bore 90 being configured to receive a respective drive pin 60 therein. As briefly described above, the drive pins 60 are configured to engage the rotor hub 22 to transfer rotational movement of the centrifuge drive 14 to the rotor 12. With brief reference to FIGS. 7-8, the drive head hub 22 includes three drive pins 60 (i.e., a first, second, and third drive pin 60) spaced apart circumferentially about the central bore 76 of the drive head hub 66. In that regard, the blind bore 90 and drive pin 60 combinations are spaced 120°apart from each other about the axial center of the hub 22 which is coaxial with the rotational axis A1. However, the drive head hub 66 may include fewer or more blind bore 90 and drive pin 60 combinations spaced apart in different configurations about the axial center of the drive head hub 66. For example, the drive head hub 66 may include two drive pin 60 and blind bore 90 combinations spaced 180° apart from each other about the axial center of the drive head hub 66. In any event, the engagement between each drive pin 60 and blind bore 90 is an interference fit, otherwise referred to as a press-fit. As a result, there may be a void between a base of each blind bore 90 and the drive pin 60, as shown in FIG. 2. However, it is understood that the drive pins 60 may be attached to the drive head hub 66 in other ways, such as by welding or by threaded engagement, for example. In one embodiment, the drive head hub 66 and the drive pins 60 may be integrally formed as a unitary piece.

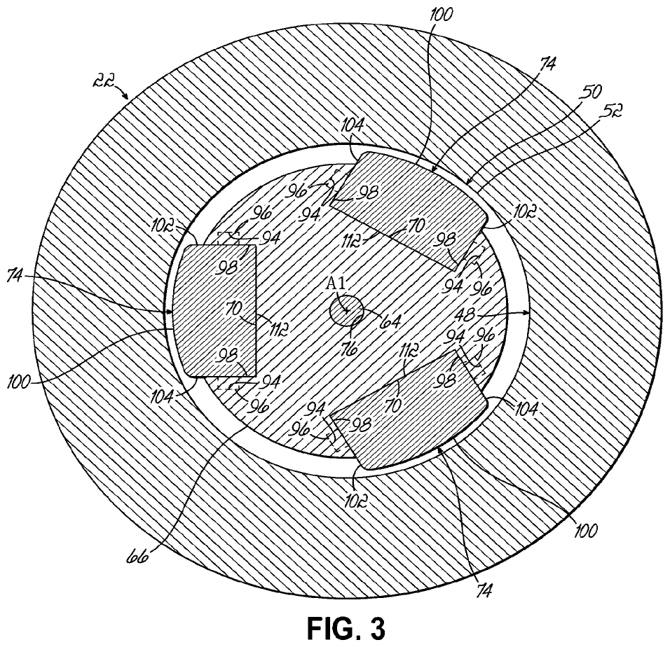

With reference to FIG. 3, the plurality of recesses 70 are spaced equidistantly apart and circumferentially about the drive head hub 66 so as to be in a symmetrical arrangement. In that regard, the three locking shoes 74 are spaced 120° apart from each other about the axial center of the drive head hub 66 so as to be positioned at 0°, 120°, and 240° thereabout. The symmetrical arrangement of the plurality of recesses 70 and locking shoes 74 about the drive head hub 66 provides for self-centering of the drive head 20 within the hub 22 of the rotor 12, as will be described in further detail below. While the drive head hub 66 includes three locking shoes 74, it is possible to provide fewer or more locking shoes 74. For example, the drive head hub 66 may include four locking shoes 74 spaced 90° apart from each other about the axial center of the drive head hub 66 so as to be positioned at 0°, 90°, 180°, and 270° thereabout.

Each locking shoe 74 is received within a corresponding recess 70 so as to be movable in a radially inward direction and a radially outward direction relative to the rotational axis A1 of the centrifuge drive 14. As shown in FIG. 2, a resilient element 92 is located between and in operative engagement with each respective locking shoe 74 and the retaining plate 68 to bias each locking shoe 74 in a radially inward direction relative to the rotational axis A1 of the centrifuge drive 14, as will be described in further detail below. Each locking shoe 74 is movably retained within a corresponding recess 70 and rotatable about a pivot axis A4 in a radially inward direction and a radially outward direction relative to the rotational axis A1 of the centrifuge drive 14. In that regard, each recess 70 includes a pair of slots 94 (i.e., a first slot 94 and a second slot 94) each being configured to receive a corresponding one of a pair of pins 96 (i.e., a first pin 96 and a second pin 96) of a locking shoe 74 therein to facilitate pivotal movement of the locking shoe 74 relative to the drive head hub 22.

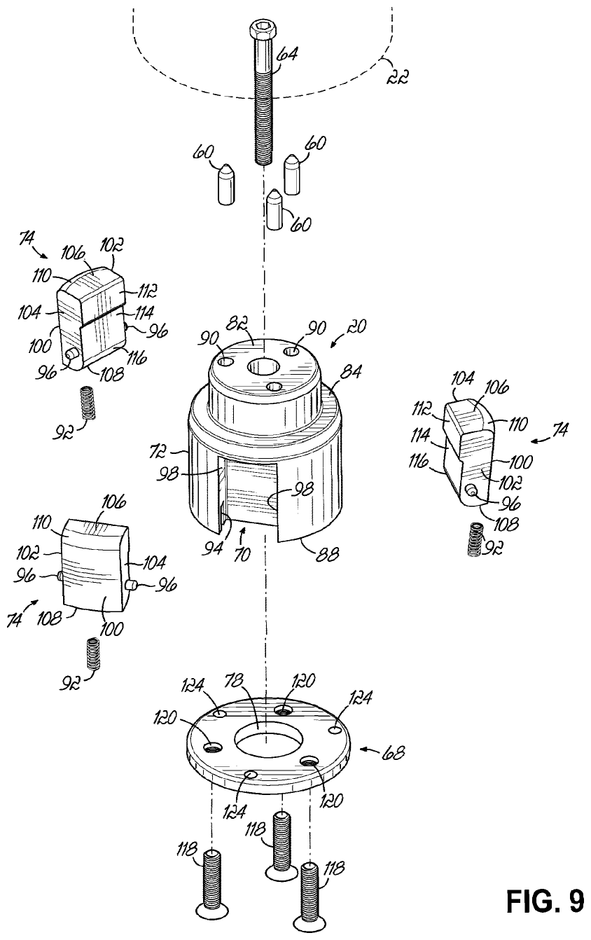

As shown in FIG. 9, each slot 94 is formed in a respective sidewall 98 of the recess 70 and extends a distance into the drive head hub 66 in an axial direction from the base 88 of the drive head hub 66. To this end, an opening to each slot 94 is formed in the base 88 of the drive head hub 66 so that each pin 96 of the locking shoe 74 may be received within a respective slot 94 to install the locking shoe 74 in the recess 70. As shown in FIG. 2, for example, the pins 96 define the pivot axis A4 for each locking shoe 74 about which the locking shoe 74 may rotate. To this end, the pivot axis A4 is perpendicular to the rotational axis A1 of the centrifuge drive 14. In one embodiment, the pins 96 may be fitted with bushings which may be formed from an engineered plastic such as Delrin®, for example, or any other suitable low friction material.

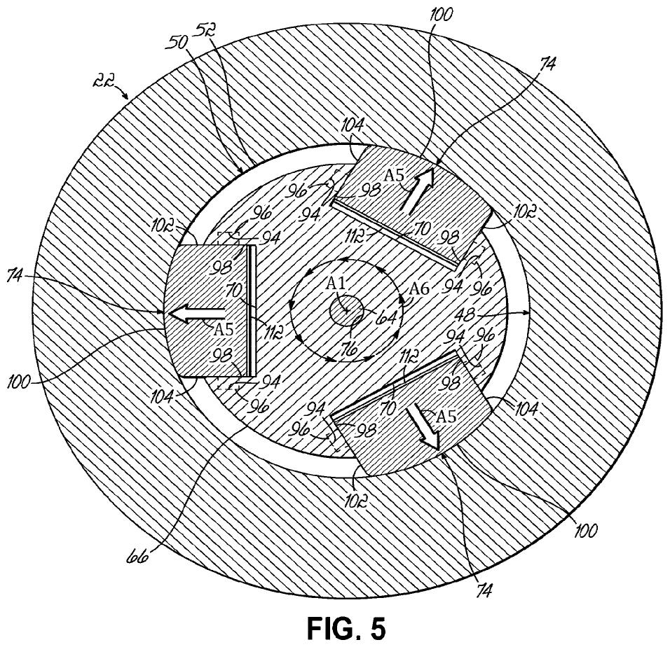

With reference to FIGS. 2-4 and 9, each locking shoe 74 includes a curved outer surface 100, a first radially extending sidewall 102, a second radially extending sidewall 104, a top surface 106 and a base surface 108. The curved outer surface 100 of each locking shoe 74 is curved in transverse cross-section and generally matches a curvature of the tapered section 52 of the interior sidewall 48 of the hub 22 of the rotor 12, as shown in FIG. 5, for example. Each locking shoe 74 further includes a first rounded surface 110 that extends between the curved outer surface 100 and the top surface 106 of the locking shoe 74. The first rounded surface 110 generally matches a curvature of the shoulder 54 of the frustoconical portion 50 of the interior sidewall 48 of the hub 22 of the rotor 12, as shown in FIG. 4, for example. To this end, when each locking shoe 74 is pivoted into engagement with the frustoconical portion 50 of the interior sidewall 48 of the hub 22 during rotation of the drive head 20, as shown in FIG. 4, the curved outer surface 100 of the locking shoe 74 exerts a radially outwardly directed force on the tapered section 52 and the first rounded surface 110 exerts a radially outwardly directed force on the shoulder 54 to thereby prevent axial movement of the centrifuge rotor 12 along the rotational axis A1 of the centrifuge drive 14 as well as rotational movement of the centrifuge rotor 12 relative to the drive head 20, and further provide for self-centering of the drive head 20 within the hub 22 of the rotor 12.

With continued reference to FIGS. 2-4 and 9, each locking shoe 74 further includes a pad 112 that projects from a back side 114 of the locking shoe 74. The pad 112 is configured to abut the drive head hub 66 when the locking shoe 74 is received within the recess 70, as shown in FIG. 2, for example. As shown in FIG. 9, the pins 96 are each located on a respective side 102, 104 of the locking shoe 74. In this regard, a first pin 96 projects from the first side 102 of the locking shoe 74 and a second pin 96 projects from the second side 104 of the locking shoe 74. The pair of pins 96 are located near the base surface 108 of the locking shoe 74, and may be located in the lower half of the locking shoe 74 or the lower third of the locking shoe 74, as shown in FIG. 2, for example. Each locking shoe 74 further includes a second rounded surface 116 that extends between the base surface 108 and the back side 114 of the locking shoe 74. Together, the base surface 108, which may be chamfered, and the second rounded surface 116 facilitate the rocking or pivoting movement of the locking shoe 74 relative to the drive head hub 66, as shown in FIGS. 2 and 4, for example.

With continued reference to FIGS. 2-4 and 9, each locking shoe 74 is movably retained within a corresponding recess by the retaining plate 68. As such, the base surface 108 and second rounded surface 116 of each locking shoe 74 may engage the retaining plate 68 as the locking shoe 74 pivots radially inwardly and radially outwardly relative to the drive head hub 66. The retaining plate 68 is generally shaped as an annular disc and is configured to be attached to the base 88 of the drive head hub 66 to limit axial movement of each of the plurality of locking shoes 74 within each respective recess 70. The retaining plate 68 is attached to the drive head hub 66 with fasteners 118 received through respective mounting bores 120 formed in the retaining plate 68. The fasteners 118 may be screws or bolts, for example, and each mounting bore 120 may include a countersink configured to receive a head of the fastener 118 therein, as shown in FIG. 2, for example.

With reference to FIGS. 2 and 4, the resilient element 92 is located between and in operative engagement with each respective locking shoe 74 and the retaining plate 68 for biasing each locking shoe 74 in a radially inward direction relative to the rotational axis A1 of the centrifuge drive 14, as shown in FIG. 2, for example. The resilient element 92 may be a compression spring sandwiched between the base surface 108 of each locking shoe 74 and the retaining plate 68. To this end, the base surface 108 of each locking shoe 74 may include a blind bore 122 formed therein and the retaining plate 68 may include a plurality of corresponding blind bores 124 formed therein, with each blind bore pair 122, 124 being configured to receive a respective end of the compression spring 92, as shown in FIG. 2, for example. In one embodiment, the compression spring 92 may be canted so such that an axial centerline of the compression spring 92 is oriented radially outwardly relative to the rotational axis A1. In another embodiment, the compression spring 92 may be oriented such that the axial centerline of the compression spring 92 is in parallel with the rotational axis A1.

With reference to FIGS. 2-5, each locking shoe 74 is pivotable between at least a first, retracted position (FIGS. 2 and 3) where each locking shoe 74 is received within a corresponding one of the plurality of recesses 70 in a radially inward direction relative to the rotational axis A1 of the centrifuge drive 14 such that the locking shoes 74 define a first outer diameter of the drive head hub 66, and a second, extended position (FIGS. 4 and 5) where each locking shoe 74, and in particular the curved outer surface 100 of each locking shoe 74, is spaced a distance from the corresponding one of the plurality of recesses 70 in a radially outward direction relative to the rotational axis A1 of the centrifuge drive 14 such that the locking shoes 74 define a second outer diameter of the drive head hub 66 that is greater than the first outer diameter. Each locking shoe 74 is in the first, retracted position when the rotor 12 is stationary. When so positioned, as shown in FIG. 2, for example, the pad 112 is in contact with the drive head hub 22.

With reference to FIGS. 4 and 4A, when each locking shoe 74 is in the second, extended position, such as when the rotor 12 is rotating at a particular speed as shown in FIG. 4, for example, the locking shoe 74 and pad 112 is pivoted or rotated away from the drive head hub 66 to place the curved outer surface 100 of each locking shoe 74 in engagement with the tapered section 52 of the interior sidewall 48 of the hub 22. When so positioned, the first rounded surface 110 of each locking shoe 74 is also in engagement with the shoulder 54. As shown in FIG. 4A, each locking shoe 74 is pivoted radially outwardly relative to the rotational axis A1 to define a tapered locking angle θ₁ of each locking shoe 74. The tapered locking angle θ₁ generally corresponds to the angle of the tapered section 52 of the interior sidewall 48 of the hub 22 relative to the rotational axis A1. In that regard, the tapered locking angle θ₁ may within a range of between 3° to 30°, and preferably between 3° to 5°.

With continued reference to FIG. 4A, when in the extended position, each of the plurality of locking shoes 74 exerts a radially outwardly directed force F on the hub 22 of the rotor 12. The force F that each locking shoe 74 exerts on the hub 22 of the rotor 12 can be determined using the following formula: F=m*r*Ω², where “m” is the weight of the locking shoe 74, “r” is the distance between the rotational axis A1 of the rotor 12 and a center of gravity 125 of the locking shoe 74, and “Ω” is a rotational velocity of the rotor 12. Notably, the center of gravity 125 of each locking shoe 74 is spaced a distance D1 in a radially outwardly direction relative to the pivot axis A4 of the locking shoe 74. As the rotational speed of the drive head 20 increases, and thus a rotational speed of the rotor 12, the force F exerted by each locking shoe 74 on the hub 22 also increases. As shown, the force F exerted by each locking shoe 74 on the hub 22 includes two force components, F_{D} and F_{G}. F_{D} is a downward locking force vector that is collinear with surfaces of the tapered section 52 of the hub 22. F_{G} is a force vector that is perpendicular to surfaces of the tapered section 52 of the hub 22. In particular, F_{G} is angled relative to F to form an angle θ₂ therebetween, with θ₂=θ₁ and F_{G}=F*cos(θ₂). To this end, F_{G} is the locking force that prevents the rotor hub 22 from moving in an upward direction along the rotational axis A1 during rotation of the rotor 12 by the drive head 20.

Having now described certain details of the rotor 12 and the drive head 20 of the centrifuge 10, the tool-less engagement between the drive head 20 and the hub 22 of the rotor 12 will now be described. In that regard, when the rotor 12 is to be connected with the drive head 20, the rotor 12 is positioned over the drive head 20 to align the drive head 20 within the hub 22 of the rotor 12. The rotor 12 is then moved downwardly until the drive head 20 is fully seated within the hub 22 of the rotor 12, as shown in FIG. 2. When so positioned, the drive pins 60 are correctly positioned within respective torque slots 58 in the hub 20 of the rotor 12 for transferring rotational movement of the centrifuge drive 14 to the centrifuge rotor 12, as described in further detail below. Furthermore, as the locking shoes 74 are biased to the first, retracted position by each resilient element 92, as shown in FIG. 3, the locking shoes 74 do not interfere with the installation of the rotor 12 to the drive head 20 or the removal of the rotor 12 from the drive head 20.

Referring now to FIGS. 3 and 5, and as briefly described above, each locking shoe 74 is configured to exert a radially outwardly directed force F on the hub 22 of the rotor 12 that increases with a rising rotational speed of the drive head 20. The radially outwardly directed force F exerted by each locking shoe 74 on the hub 22 of the rotor 12 serves to prevent axial movement of the centrifuge rotor 12 along the rotational axis A1 of the centrifuge drive 14 as well as rotational movement of the centrifuge rotor 12 relative to the drive head 20. In that regard, FIG. 3 illustrates each locking shoe 74 in the retracted position when the rotor 12 is stationary with the curved outer surface 100 of each locking shoe 74 moved away from the interior sidewall 48 of the hub 22 of the rotor 12.

FIG. 5 illustrates each locking shoe 74 in an extended position and further illustrates pivotal movement of each locking shoe 74 relative to the the hub 22, as indicated by directional arrows A5, when the rotor 12 is rotating at a particular speed, as indicated by directional arrows A6. During rotation of the rotor 12 by the drive head 20, the centrifugal force component F of each locking shoe 74 overcomes the opposing biassing force exerted by the resilient element 92 to pivot each locking shoe 74 (i.e., rotate the locking shoe 74 about the pivot axis A4) in a radially outwardly direction and into engagement with the frustoconical portion 52 of the interior sidewall 48 of the rotor hub 22. As the rotational speed of the drive head 20 increases, and thus a rotational speed of the rotor 12, the centrifugal force component F acting on each locking shoe 74 also increases, thereby increasing the contact force between each locking shoe 74 and the rotor hub 22. To this end, deceleration of the rotor 12 decreases the contact force between each locking shoe 74 and the hub 22.

The force F exerted by each locking shoe 74 on the hub 22 results in a static friction coefficient F_{sf} (e.g., a radial and an axial holding force, otherwise referred to as a friction force) between each locking shoe 74 and the interior sidewall 48 of the rotor hub 22. In that regard, the static friction coefficient F_{sf} is a function of the coefficient of friction “μ” between the contacting surfaces 100, 48 and the contact force F. That is, F_{sf}=μ*F. Generally, as the contact force F increases with the increase of rotor 12 speed, so does the static friction coefficient F_{sf} (e.g., the radial and axial holding forces). The angled engagement (i.e., the tapered locking angle θ₁) between the tapered section 52 of the sidewall 48 of the hub 22 and each locking shoe 74, otherwise referred to as a reverse conical engagement, results in greater axial holding forces compared to a non-angled or non-conical engagement, for example. In any event, as each locking shoe 74 and the hub 22 of the rotor 12 may be formed from steel, such as 316L stainless steel, for example, the coefficient of friction μ between surfaces of each locking shoe 74 and the sidewall 48 of the rotor hub 22 may be between 0.3 to 0.5, for example. However, the surface roughness of surfaces of each locking shoe 74, and in particular the curved outer surface 100 and the first rounded surface 110 of each locking shoe 74 and the sidewall 48 of the rotor hub 22 may be changed to improve the coefficient of friction μ therebetween. For example, the surfaces 100, 110, 48 may be machined and processed with different Ra (roughness average), such as 15 Ra, for example, resulting in a coefficient of friction μ therebetween that is within a range of between 0.3 to 0.8, for example.

In view of the above, the weight of each locking shoe 74 is an important design requirement for the operation of the drive head 20. In that regard, the weight of each locking shoe 74 should be as heavy as possible to increase the value of F_{sf}, particularly at lower rotational speeds of the rotor 12. To this end, the three locking shoe 74 design provides for both the self-centering effect of the drive head hub 20 as well as a large size and mass of each locking shoe 74. Thus, while it is possible to have fewer or more locking shoes 74, such as two or four, for example, each design sacrifices either the self-centering effect (e.g., two locking shoes 74) or requires a smaller size and thus smaller mass of each locking shoe 74 (e.g., four locking shoes 74).

Testing was run on a prototype of the centrifuge 10 assembly described above and another advantage of the connection between the drive head 20 and the rotor 12 during operation of the centrifuge 10 was observed. In that regard, the centrifuge 10 was observed to be exceptionally quiet during operation, and the decibel (dB) output was measured to be 57.6 dB at a rotational speed of 16,500 rpm.

Referring now to FIGS. 2 and 7-8, when the drive head 20 is fully seated within the rotor hub 22, as shown in FIG. 2, the rotor 12 is considered mounted to the centrifuge drive 14. When so positioned, the drive pins 60 are received within respective torque slots 58 and configured to engage a sidewall 126 of each respective torque slot 58 to minimize movement of the drive head 20 relative to the rotor 12 during initial acceleration or deceleration of the rotor 12 by the drive 14. The engagement between the drive pins 60 and the torque slots 58 may also transfer rotational movement of the centrifuge drive 14 to the centrifuge rotor 12 during initial acceleration or deceleration of the rotor 12 by the drive 14. As shown in FIGS. 7-8, the torque slots 58 are formed as oblong arc-shaped blind bores having a slightly curved profile that generally conforms to circumference of the base surface 46 of the rotor hub 22. In that regard, the torque slots 58 are formed in the base surface 46 of the rotor hub 22 and are spaced apart circumferentially, in an end-to-end symmetrical arrangement, about the axial center of the hub 22 which is coaxial with the rotational axis A1. To this end, while the rotor hub 22 includes four torque slots 58, it is possible to provide fewer or more torque slots 58.

Referring now to FIGS. 7-8, the drive head 20 is fully seated within the rotor hub 22 resulting in a first drive pin 60 being positioned within a first torque slot 58, a second drive pin 60 being positioned within a second torque slot 58, and a third drive pin 60 being positioned within a third torque slot 58. In particular, the first drive pin 60 is in an abutting or near-abutting relationship with a rightmost arcuate portion 128 of the sidewall 126 of the first torque slot 58 (i.e., a rightmost portion of the torque slot sidewall 126 measured in a radial direction about the axial center of the rotor hub 22) and the second drive pin 60 is positioned in an abutting or near-abutting relationship with a leftmost arcuate portion 130 of the sidewall 126 of the second torque slot 58 (i.e., a leftmost portion of the torque slot sidewall 126 measured in a radial direction about the axial center of the rotor hub 22). The third drive pin 60 is positioned centrally within the third torque slot 58. As shown, the first drive pin 60 and the second drive pin 60 do not both abut the arcuate portions 128, 130 of the sidewalls 126 of the first and second torque slots 58 at the same time. Rather, only one of the drive pins 60 is in an abutting relationship with the respective arcuate portion 128, 130 of the torque slot sidewall 126, depending on whether the rotor 12 is being accelerated or decelerated. This configuration results in a small gap being formed between the drive pin 60 and the corresponding sidewall 126 that are not engaged, as described in further detail below.

FIG. 7 illustrates the rotor 12 being accelerated to a particular rotational speed by the drive head 20, as indicated by directional arrows A7. As shown, during acceleration, the first drive pin 60 is in an abutting relationship with the rightmost arcuate portion 128 of the sidewall 126 of the first torque slot 58 to transfer torque from the drive head 20 to the rotor 12, as indicated by directional arrow A8. To this end, the engagement between the first drive pin 60 and the first torque slot 58 prevents rotation of the drive head 20 relative to the centrifuge rotor 12 during acceleration of the centrifuge rotor 12 by the centrifuge drive 14. Also during acceleration of the rotor 12, the second drive pin 60 is spaced away from the leftmost arcuate portion 130 of the sidewall 126 of the second torque slot 58 such that a gap 132 is formed therebetween.

FIG. 8 illustrates the rotor 12 during deceleration or braking, as indicated by directional arrows A9. In that regard, the rotor 12 is rotating at a particular rotational speed that is less than the speed of the rotor 12 illustrated in FIG. 7. As shown, during deceleration, the second drive pin 60 is in an abutting relationship with the leftmost arcuate portion 130 of the sidewall 126 of the second torque slot 58 to transfer torque from the drive head 20 to the rotor 12, as indicated by directional arrow A10. To this end, the engagement between the second drive pin 60 and the second torque slot 58 prevents rotation of the drive head 20 relative to the centrifuge rotor 12 during deceleration of the centrifuge rotor 12 by the centrifuge drive 14. Also during deceleration of the rotor 12, the first drive pin 60 is spaced away from the rightmost arcuate portion 128 of the sidewall 126 of the first torque slot 58 such that a gap 134 is formed therebetween. The size of the gap 134 may the similar to the gap 132 described above with respect to FIG. 7.

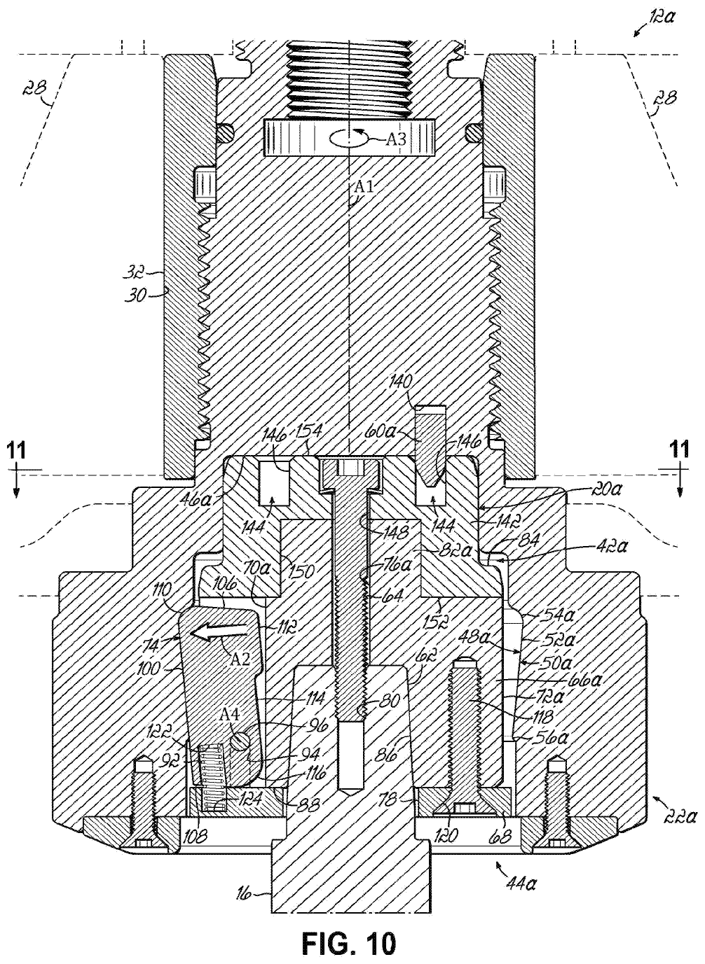

Referring now to FIGS. 10-12, wherein like numerals represent like features, a second embodiment of the drive head 20a of the present invention is shown and will now be described. Like the previously described embodiment, the drive head 20a forms part of the centrifuge 10a and is used to detachably couple a centrifuge rotor 12a to the spindle 16 of the centrifuge drive 14a that is driven by the motor 18 to thereby rotate the rotor 12 about the rotational axis A1 to achieve high-speed, centrifugal rotation of the rotor 12. The primary differences between the centrifuge 10a of this embodiment and the centrifuge 10 of the previously described embodiment is the configuration of the drive head 20a and the configuration of the rotor hub 22a. To this end, while the centrifuge 10a and the centrifuge drive 14a are not entirely shown in FIG. 10, it is understood that they are similar to the centrifuge 10 and the centrifuge drive 14 described above with respect to FIG. 1, for example.

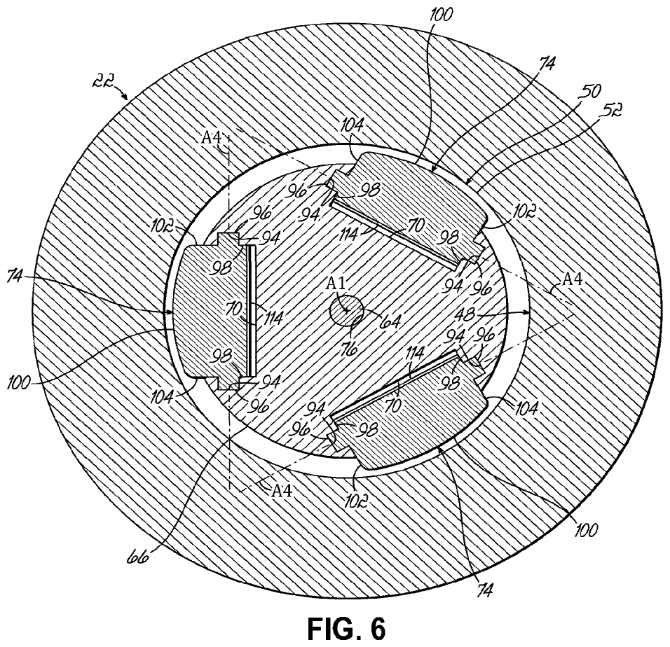

With reference to FIG. 10, the exemplary centrifuge rotor 12a is similar in many respects to the rotor 12 described above with respect to FIGS. 1-7, and thus like reference numerals represent like features. As such, certain features will not be redescribed. As shown, the rotor 12a includes the rotor hub 22a which defines the internal cavity 42a configured to receive the drive head 20a of the centrifuge drive 14a therein for coupling the rotor 12a to the centrifuge drive 14a in a tool-less manner. The internal cavity 42a extends from an open end 44a of the hub 22 to a radially extending base surface 46a of the hub 22a to define an interior sidewall 48a of the hub 22. The interior sidewall 48a includes a frustoconical shaped portion 50a configured to receive one or more locking shoes 74 of the drive head hub 22a during rotation of the centrifuge rotor 12a by the centrifuge drive 14a. The frustoconical portion 50a is defined by a tapered section 52a of the sidewall 48a that extends from a lip 56a to a shoulder 54a. To this end, the tapered section 52a extends at an angle of between 5° to 30° relative to vertical (e.g., the rotational axis A1). The base surface 46a of the hub 22a includes a plurality of blind bores 140 formed therein with each blind bore 140 being configured to receive a corresponding drive pin 60a therein to transfer rotational movement of the centrifuge drive 14a to the centrifuge rotor 12a, as described in further detail below.

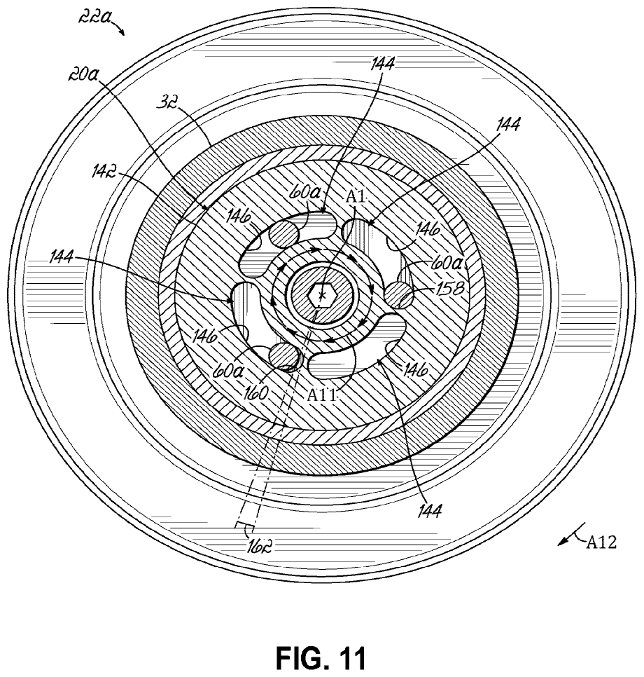

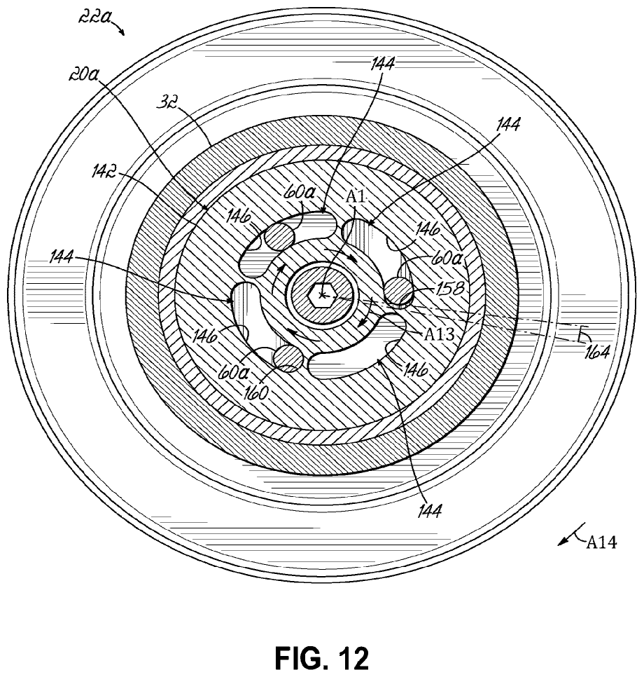

Each blind bore 140 is configured to receive a corresponding drive pin 60a therein and, in the embodiment shown, the hub 22a includes three blind bore 140 and drive pin 60a combinations. The blind bore 140 and drive pin 60a combinations are spaced 120° apart from each other about the axial center of the hub 22 which is coaxial with the rotational axis A1 (e.g., FIGS. 11 and 12). However, the hub 22a may include fewer or more blind bore 140 and drive pin 60a combinations spaced apart in different configurations about the axial center of the hub 22a. For example, the hub 22a may include two blind bore 140 and drive pin 60a combinations spaced 180° apart from each other about the axial center of the hub 22a. In any event, the engagement between each drive pin 60a and blind bore 140 is an interference fit, otherwise referred to as a press-fit. As a result, there may be a void between a base of each blind bore 140 and the drive pin 60a, as shown in FIG. 10, for example. However, it is understood that the drive pins 60a may be attached to the hub 22a in other ways, such as by welding or by threaded engagement, for example. In one embodiment, the hub 22a and drive pins 60a may be integrally formed as a unitary piece.

With reference to FIG. 10, the drive head 20a is mounted to the distal end 62 of the spindle 16 with a fastener 64 and includes a drive head hub 66a, a crown 142, and a retaining plate 68 coupled together in a coaxial arrangement. When the drive head 20a is fully seated within the rotor hub 22a, as shown in FIG. 10, the drive pins 60a are received within respective torque slots 144 formed in the crown 142 to thereby engage a sidewall 146 of each respective torque slot 144 to minimize movement of the drive head 20a relative to the rotor 12a during initial acceleration or deceleration of the rotor 12a by the drive 14a, as will be described in further detail below. The crown 142, drive head hub 66a and the retaining plate 68 each include a central bore 148, 76a, 78, respectively. The central bores 148, 76a formed in the crown 142 and the drive head hub 66a, respectively, are configured to receive the fastener 64 therethrough for attaching the drive head 20a to the distal end 62 of the spindle 16, as shown.

Like the drive head hub 66 described above with respect to FIGS. 1-9, the drive head hub 66a includes a plurality of radially movable locking shoes 74 that are configured to exert a radially outwardly directed force F on the hub 22a of the rotor 12a that increases with a rising rotational speed of the drive head 20a. Each locking shoe 74 is movably retained within a corresponding recess 70a formed in an outer sidewall 72a of the drive head hub 66a. A resilient element 92 is located between each locking shoe 74 and the retaining plate 68, and each locking shoe 74 is pivotably movable about a pivot axis A4 within a corresponding recess 70a such that a portion of the locking shoe 74 rotates about the pivot axis A4 in a radially inward direction and a radially outward direction relative to the rotational axis A1 of the centrifuge drive 14a. To this end, each locking shoe 74 is movable in a radially outwardly direction, as indicated by directional arrow A2, to exert a radially outwardly directed force F on the interior sidewall 48a of the hub 22a of the centrifuge rotor 12a that increases with a rising rotational speed of the drive head 20a to prevent axial movement of the centrifuge rotor 12a along the rotational axis A1 of the centrifuge drive 14a and rotational movement of the centrifuge rotor 12a relative to the drive head 20a, as described above with respect to FIGS. 1-9.

With continued reference to FIG. 10, the crown 142 is configured to be attached to the drive head hub 66a and includes a pocket 150 formed in a base 152 of the crown 142 that is configured to receive the boss 82a of the drive head hub 66a therein for coupling the crown 142 to the drive head hub 66a. In that regard, the boss 82a of the drive head hub 66a is configured to be fully received within the pocket 150 of the crown 142 to thereby place the base 152 of the crown 142 in engagement with the top surface 76a of the drive head hub 66a. In that regard, each locking shoe 74 is positioned within each recess 70a between the base 152 of the crown 142 and the retaining plate 68.

The fit between the pocket 150 of the crown 142 and the boss 82a of the drive head hub 66a may be an interference fit, for example. The crown 142 further includes the plurality of torque slots 144 formed in a top surface 154 of the crown 142 with each torque slot 144 being configured to receive a corresponding drive pin 60a therein to transfer rotational movement of the centrifuge drive 14a to the centrifuge rotor 12a, as described in further detail below. The central bore 148 formed in the crown 142 extends in an axial direction between the top surface 154 and the pocket 150 of the crown 142 and may include a countersink formed in the top surface 154 that is configured to receive a head of the fastener 64 therein, as shown.

With reference to FIGS. 11-12, the drive head 20a is fully seated within the rotor hub 22a resulting in a first drive pin 60a being positioned within a first torque slot 144, a second drive pin 60a being positioned within a second torque slot 144, and a third drive pin 60a being positioned within a third torque slot 144. In particular, the first drive pin 60a is in an abutting or near-abutting relationship with a rightmost arcuate portion 158 of the sidewall 146 of the first torque slot 144 (i.e., a rightmost portion of the torque slot sidewall 146 measured in a radial direction about the axial center of the rotor hub 22a) and the second drive pin 60a is positioned in an abutting or near-abutting relationship with a leftmost arcuate portion 160 of the sidewall 146 of the second torque slot 144 (i.e., a leftmost portion of the torque slot sidewall 146 measured in a radial direction about the axial center of the rotor hub 22a). The third drive pin 60a is positioned centrally within the third torque slot 144. As shown, the first drive pin 60a and the second drive pin 60a do not both abut the arcuate portions 158, 160 of the sidewalls 146 of the first and second torque slots 144 at the same time. Rather, only one of the drive pins 60a is in an abutting relationship with the respective arcuate portion 158, 160 of the torque slot sidewall 146, depending on whether the rotor 12a is being accelerated or decelerated. This configuration results in a small gap being formed between the drive pin 60a and the corresponding sidewall 126 that are not engaged, as described in further detail below.

FIG. 11 illustrates the rotor 12a being accelerated to a particular rotational speed by the drive head 20a, as indicated by directional arrows A11. As shown, during acceleration, the first drive pin 60a is in an abutting relationship with the rightmost arcuate portion 158 of the sidewall 146 of the first torque slot 144 to transfer torque from the drive head 20a to the rotor 12a, as indicated by directional arrow A12. To this end, the engagement between the first drive pin 60a and the first torque slot 144 prevents rotation of the drive head 20a relative to the centrifuge rotor 12a during acceleration of the centrifuge rotor 12a by the centrifuge drive 14a. Also during acceleration of the rotor 12a, the second drive pin 60a is spaced away from the leftmost arcuate portion 160 of the sidewall 146 of the second torque slot 144 such that a gap 162 is formed therebetween.

FIG. 12 illustrates the rotor 12a during deceleration or braking, as indicated by directional arrows A13. In that regard, the rotor 12a is rotating at a particular rotational speed that is less than the speed of the rotor 12a illustrated in FIG. 11. As shown, during deceleration, the second drive pin 60a is in an abutting relationship with the leftmost arcuate portion 160 of the sidewall 146 of the second torque slot 144 to transfer torque from the drive head 20a to the rotor 12a, as indicated by directional arrow A14. To this end, the engagement between the second drive pin 60a and the second torque slot 144 prevents rotation of the drive head 20a relative to the centrifuge rotor 12a during deceleration of the centrifuge rotor 12a by the centrifuge drive 14a. Also during deceleration of the rotor 12a, the first drive pin 60a is spaced away from the rightmost arcuate portion 158 of the sidewall 146 of the first torque slot 144 such that a gap 164 is formed therebetween. The size of the gap 164 may the similar to the gap 162 described above with respect to FIG. 11.

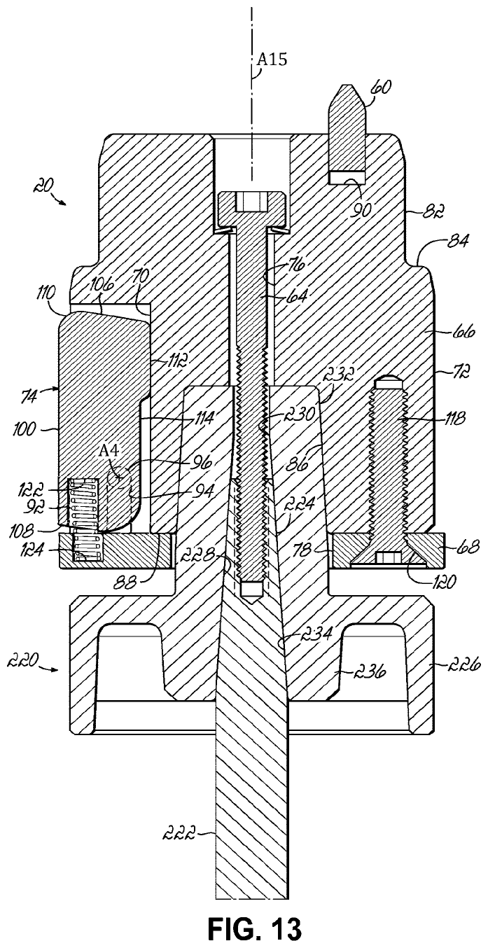

Referring now to FIG. 13, wherein like numerals represent like features, details of an adapter 220 for attaching either of the above-described drive heads 20, 20a to a spindle 222 of a centrifuge (not shown) that has different dimensions compared to the spindle 16 of the centrifuges 10, 10a described above are shown in accordance with another embodiment of the invention. In that regard, the distal end 224 of the spindle 222 is smaller in diameter compared to the distal end 62 of the spindle 16 described above, and consequently would not properly fit within the pocket 86 formed in the base 88 of the drive head hub 66. In another embodiment, an adapter may be provided to attach the drive head 20, 20a to the distal end 224 of a spindle that is larger in diameter compared to the distal end 62 of the spindle 16 described above. As described in further detail below, the adapter 220 fits to the distal end 224 of the spindle 222 and a portion of the adapter 220 is received within the pocket 86 of the drive head hub 66 so that the drive head 20 may be operably coupled to the spindle 222.

With continued reference to FIG. 13, the adapter 220 includes a cupped flange 226 and a mounting bore 228 that extends axially through the adapter 220 and between a first opening 230 to the mounting bore 228 formed in a first projection 232 of the adapter 220 and a second opening 234 to the mounting 228 formed in a second projection 236 of the adapter 220. The first and second projections 232, 236 project from the flange in axially opposite directions such that the mounting bore 228 is formed through the axial center of the adapter 220. As shown, the axial center of the adapter 220 is coaxial with an axis of rotation A15 of the spindle 222, the drive head 20, and the adapter 220. The first opening 230 formed in the first projection 232 has a diameter that is smaller in size compared to a diameter of the second opening 234 formed in the second projection 236. In that regard, a diameter of the mounting bore 228 gradually decreases in size along an axial length of the mounting bore 228 and in a direction from the second opening 234 to the first opening 230. As such, the mounting bore 228 is generally frustoconical in shape. To this end, the configuration of the mounting bore 228 may be changed depending on the type of centrifuge being used.

As shown, the second opening 234 is configured to receive the distal end 224 of the spindle 222 therethrough and the first opening 230 is configured to receive a fastener 238 therethrough for securing the adapter 220 and the drive head 220 to the spindle 222. In that regard, the distal end 224 of the spindle 222 is received into the mounting bore 228 through the second opening 234 to position the distal end 224 of the spindle 222 within the mounting bore 228, as shown. The fit between the distal end 224 of the spindle 222 and the mounting bore 228 may be a friction fit to secure the adapter 220 to the spindle 222, for example. To this end, the mounting bore 228 may have different configurations based on the configuration of the spindle 222. For example, the mounting bore 228 may have a constant diameter between the first opening 230 and the second opening 234.

The first projection 232 of the adapter 220 is generally frustoconical in shape and is sized to be received within the pocket 86 of the drive head hub 66 to couple the drive head 20 to the adapter 220, as shown. That is, an outer profile of the first projection 232 generally corresponds to a profile of the pocket 86. The fit between the first projection 232 of the adapter 220 and the pocket 86 of the drive head hub 66 may be a friction fit, for example. The adapter 220 is configured to be sandwiched between the drive head 20 and the distal end 224 of the spindle 222 in a coaxial arrangement, as shown, with the drive head 20 and the adapter 220 being mounted to the distal end 224 of the spindle 222 with the fastener 238. To this end, the fastener 238, which may be a bolt or screw, for example, is received through aligned bores 76, 228 and threaded into a threaded bore 240 in the distal end 224 of the spindle 222 to secure the drive head 20 and the adapter 220 to the spindle 222.

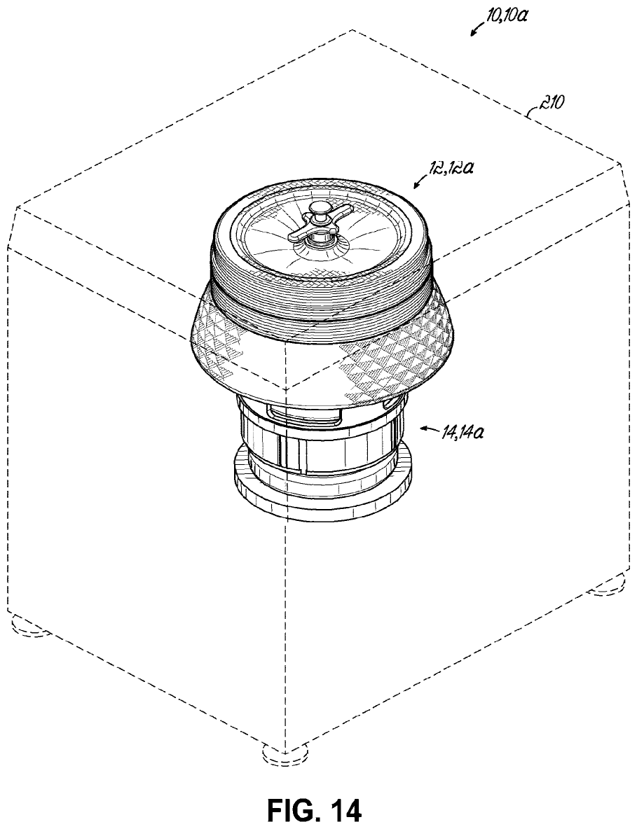

FIG. 14 depicts the exemplary centrifuge 10, 10a which includes a housing 210, the drive 14, 14a, and one of the above-described rotors 12, 12a coupled to the drive 14, 14a with one of the above-described drive heads 20, 20a. In operation, the drive 14, 14a imparts rotation to the spindle (not shown) that, in turn, provides a rotational torque to the rotor 12, 12a to rotate the rotor 12, 12a at a desired speed.

While the invention has been illustrated by the description of various embodiments thereof, and while the embodiments have been described in considerable detail, it is not intended to restrict or in any way limit the scope of the appended claims to such detail. Thus, the various features discussed herein may be used alone or in any combination. Additional advantages and modifications will readily appear to those skilled in the art. The invention in its broader aspects is therefore not limited to the specific details and illustrative examples shown and described. Accordingly, departures may be made from such details without departing from the scope of the general inventive concept.

1. A drive head for a centrifuge drive that is configured to be received within a hub of a centrifuge rotor for coupling the centrifuge rotor to the centrifuge drive for rotation of the centrifuge rotor by the centrifuge drive about a rotational axis of the centrifuge drive, the hub of the centrifuge rotor having at least one torque slot formed therein, the drive head comprising:
a drive head hub including a spindle socket configured to receive a spindle of the centrifuge drive and a central bore configured to receive a fastener therethrough to couple the drive head to the spindle, the drive head hub comprising:
a boss that projects upwardly from a top surface of the drive head hub, the boss including at least one drive pin configured to engage the at least one torque slot formed in the hub of the centrifuge rotor to transfer rotational movement of the centrifuge drive to the centrifuge rotor; and
a plurality of recesses formed in an outer sidewall of the drive head hub and spaced circumferentially about the drive head hub;
a retaining plate attached to a base of the drive head hub, the retaining plate including a central bore configured to receive a distal end of the spindle therethrough;
a locking shoe movably retained within each of the plurality of recesses by the retaining plate so as to be pivotable about a pivot axis in a radially inward direction and a radially outward direction relative to the rotational axis of the centrifuge drive; and
a resilient element located between and in operative engagement with each respective locking shoe and the retaining plate for biasing each locking shoe in the radially inward direction relative to the rotational axis of the centrifuge drive;
wherein each locking shoe is configured to exert a radially outwardly directed force on a tapered section of an interior sidewall of the hub of the centrifuge rotor during rotation of the centrifuge rotor by the centrifuge drive to prevent axial movement of the centrifuge rotor along the rotational axis of the centrifuge drive and rotational movement of the centrifuge rotor relative to the drive head, with the radially outwardly directed force increasing with a rising rotational speed of the drive head.

2. The drive head of claim 1, wherein each locking shoe includes a curved outer surface in transverse cross-section that matches a curvature of the interior sidewall of the hub of the centrifuge rotor, and wherein each locking shoe includes a rounded surface that extends between the curved outer surface and a top surface of each locking shoe that is configured to engage a shoulder formed in the interior sidewall of the hub of the centrifuge.

3. (canceled)

4. The drive head of claim 1, wherein each locking shoe is pivotable between:
a retracted position wherein each locking shoe is received within a corresponding one of the plurality of recesses in a radially inward direction relative to the rotational axis of the centrifuge drive to define a first outer diameter of the drive head hub; and
an extended position wherein each locking shoe projects a distance from the corresponding one of the plurality of recesses in a radially outward direction relative to the rotational axis of the centrifuge drive to define a second outer diameter of the drive head hub that is greater than the first outer diameter.

5. The drive head of claim 1, wherein the plurality of recesses are spaced equidistantly apart about a circumference of the drive head hub to provide self-centering of the drive head within the hub of the centrifuge rotor by each locking shoe, wherein the pivot axis is perpendicular to the rotational axis of the centrifuge drive.

6. (canceled)

7. The drive head of claim 1, wherein each locking shoe includes a first pin that projects from a first side of the locking shoe and a second pin that projects from a second side of the locking shoe, wherein the first pin and the second pin define the pivot axis of the locking shoe, and wherein each of the plurality of recesses includes a first sidewall having a first slot configured to movably receive the first pin of the locking shoe therein and a second sidewall having a second slot configured to movably receive the second pin of the locking shoe therein.

8. (canceled)

9. The drive head of claim 4, wherein the locking shoe includes a pad that projects from a back side of the locking shoe, the pad being configured to abut the drive head hub when the locking shoe is in the retracted position and be spaced away from the drive head hub when the locking shoe is in the extended position.

10. The drive head of claim 1, wherein the resilient element extends between a blind bore formed in a base of the locking shoe and a blind bore formed in the retaining plate, or wherein the at least one drive pin comprises a first, second, and third drive pin spaced apart circumferentially about the central bore of the drive head hub.

11. (canceled)

12. A centrifuge, comprising:
the drive head of claim 1; and
a centrifuge rotor including a hub configured to receive the drive head therein, the hub including at least one torque slot formed therein that is configured to receive the at least one drive pin of the drive head hub for transferring rotational movement of the centrifuge drive to the centrifuge rotor.

13. The centrifuge of claim 12, wherein the hub of the centrifuge rotor includes an interior sidewall having a tapered section that defines a shoulder, wherein each locking shoe is configured to exert a radially outwardly directed force on the tapered section and shoulder of the interior sidewall of the hub during rotation of the centrifuge rotor by the centrifuge drive, wherein each torque slot is an arc-shaped blind bore, or wherein the at least one torque slot comprises four torque slots spaced apart circumferentially about a central bore formed in the hub, wherein a first drive pin of the drive head hub is configured to engage a sidewall of a first torque slot to prevent rotation of the drive head relative to the centrifuge rotor during acceleration of the centrifuge rotor by the centrifuge drive, and wherein a second drive pin of the drive head hub is configured to engage a sidewall of a second torque slot to prevent rotation of the drive head relative to the centrifuge rotor during deceleration of the centrifuge rotor by the centrifuge drive.

14. (canceled)

15. (canceled)

16. (canceled)

17. (canceled)

18. A drive head for a centrifuge drive that is configured to be received within a hub of a centrifuge rotor for coupling the centrifuge rotor to the centrifuge drive for rotation of the centrifuge rotor by the centrifuge drive about a rotational axis of the centrifuge drive, the hub of the centrifuge rotor having at least one drive pin for transferring rotational movement of the centrifuge drive to the centrifuge rotor, the drive head comprising:
a drive head hub including a spindle socket configured to receive a spindle of the centrifuge drive and a central bore configured to receive a fastener therethrough to couple the drive head to the spindle, the drive head hub comprising a plurality of recesses formed in an outer sidewall of the drive head hub and spaced circumferentially about the drive head hub;
a retaining plate attached to a base of the drive head hub, the retaining plate including a central bore configured to receive a distal end of the spindle therethrough;
a locking shoe movably retained within each of the plurality of recesses by the retaining plate so as to be pivotable about a pivot axis in a radially inward direction and a radially outward direction relative to the rotational axis of the centrifuge drive; and
a resilient element located between and in operative engagement with each respective locking shoe and the retaining plate for biasing each locking shoe in the radially inward direction relative to the rotational axis of the centrifuge drive;
wherein each locking shoe is configured to exert a radially outwardly directed force on a tapered section of an interior sidewall of the hub of the centrifuge rotor during rotation of the centrifuge rotor by the centrifuge drive to prevent axial movement of the centrifuge rotor along the rotational axis of the centrifuge drive and rotational movement of the centrifuge rotor relative to the drive head, with the radially outwardly directed force increasing with a rising rotational speed of the drive head.

19. The drive head of claim 18, further comprising:
a crown attached to a top of the drive head hub, the crown including a central bore configured to receive the fastener therethrough and a plurality of torque slots formed in a top surface of the crown that are configured to receive the at least one drive pin of the hub of the centrifuge rotor therein to transfer rotational movement of the centrifuge drive to the centrifuge rotor, wherein each locking shoe includes a curved outer surface in transverse cross-section that matches a curvature of the interior sidewall of the hub of the centrifuge rotor, and wherein each locking shoe includes a rounded surface that extends between the curved outer surface and a top surface of each locking shoe that is configured to engage a shoulder formed in the interior sidewall of the hub of the centrifuge.

20. (canceled)

21. (canceled)

22. The drive head of claim 18, wherein each locking shoe is pivotable between:
a retracted position wherein each locking shoe is received within a corresponding one of the plurality of recesses in a radially inward direction relative to the rotational axis of the centrifuge drive to define a first outer diameter of the drive head hub; and
an extended position wherein each locking shoe projects a distance from the corresponding one of the plurality of recesses in a radially outward direction relative to the rotational axis of the centrifuge drive to define a second outer diameter of the drive head hub that is greater than the first outer diameter.

23. The drive head of claim 18, wherein the plurality of recesses are spaced equidistantly apart about a circumference of the drive head hub to provide self-centering of the drive head within the hub of the centrifuge rotor by each locking shoe, or wherein the pivot axis is perpendicular to the rotational axis of the centrifuge drive.

24. (canceled)

25. The drive head of claim 18, wherein each locking shoe includes a first pin that projects from a first side of the locking shoe and a second pin that projects from a second side of the locking shoe, wherein the first pin and the second pin define the pivot axis of the locking shoe, and wherein each of the plurality of recesses includes a first sidewall having a first slot configured to movably receive the first pin of the locking shoe therein and a second sidewall having a second slot configured to movably receive the second pin of the locking shoe therein.

26. (canceled)

27. The drive head of claim 22, wherein the locking shoe includes a pad that projects from a back side of the locking shoe, the pad being configured to abut the drive head hub when the locking shoe is in the retracted position and be spaced away from the drive head hub when the locking shoe is in the extended position, or wherein the resilient element extends between a blind bore formed in a base of the locking shoe and a blind bore formed in the retaining plate.

28. (canceled)

29. A centrifuge, comprising:
the drive head of claim 19; and
a centrifuge rotor including a hub configured to receive the drive head therein, the hub including at least one drive pin that projects from an interior surface of the hub in an axially downward direction relative to the rotational axis of the centrifuge drive, the at least one drive pin configured to transfer rotational movement of the centrifuge drive to the centrifuge rotor.

30. The centrifuge of claim 29, wherein the hub of the centrifuge rotor includes an interior sidewall having a tapered section that defines a shoulder, wherein each locking shoe is configured to exert a radially outwardly directed force on the tapered section and shoulder of the interior sidewall of the hub during rotation of the centrifuge rotor by the centrifuge drive, and wherein each torque slot is an arc-shaped blind bore.

31. (canceled)

32. The centrifuge of claim 29, wherein at least one torque slot comprises four torque slots spaced apart circumferentially about a central bore formed in the hub, wherein a first drive pin of the crown is configured to engage a sidewall of a first torque slot to prevent rotation of the drive head relative to the centrifuge rotor during acceleration of the centrifuge rotor by the centrifuge drive, and wherein a second drive pin of the crown of the centrifuge rotor is configured to engage a sidewall of a second torque slot to prevent rotation of the drive head relative to the centrifuge rotor during deceleration of the centrifuge rotor by the centrifuge drive.

33. (canceled)

34. (canceled)

35. An adapter for mounting a drive head to a spindle of a centrifuge drive, the drive head being configured to be received within a hub of a centrifuge rotor for coupling the centrifuge rotor to the centrifuge drive for rotation of the centrifuge rotor by the centrifuge drive about a rotational axis of the centrifuge drive, the drive head including a central bore configured to receive a fastener therethrough to couple the drive head to a distal end of the spindle of the centrifuge drive, the adapter comprising:
a first projection configured to be received within a pocket formed in the drive head;
a second projection that projects in an axially opposite direction from the first projection; and
a mounting bore that extends axially through the adapter and between a first opening to the mounting bore formed in the first projection of the adapter and a second opening to the mounting formed in the second projection of the adapter;
wherein the mounting bore is configured to receive the distal end of the spindle through the second opening such that the central bore of the drive head, the mounting bore, and a threaded bore in the distal end of the spindle are coaxially arranged to receive the fastener therethrough to couple the drive head and the adapter to the distal end of the spindle of the centrifuge drive.

36. The adapter of claim 35, further comprising a cupped flange located axially between the first projection and the second projection, wherein the first projection is frustoconical in shape, or wherein the mounting bore is frustoconical in shape.

37. (canceled)

38. (canceled)
